(19) United States
(12) Patent Application Publication
(10) Pub. No.: US 2025/0032966 A1
(43) Pub. Date: Jan. 30, 2025

(54) PATHOGEN DEACTIVATING AIR FILTER SYSTEMS

(71) Applicant: Suresh BHATE, Niskayuna, NY (US)

(72) Inventor: Suresh BHATE, Niskayuna, NY (US)

(21) Appl. No.: 18/358,665

(22) Filed: Jul. 25, 2023

(51) Int. Cl. B01D 46/00; B01D 39/12

(52) U.S. Cl. CPC B01D 46/0006; B01D 39/12; B01D 2279/65

(57) ABSTRACT

The present disclosure relates generally to air filter systems comprising a base filter portion and a particulate filter. The base filter portion comprises a pathogen deactivation filter portion with copper (or copper alloy) medium to inactivate airborne pathogens (e.g., viruses, bacteria, coronaviruses, COVID-19, etc.) and mitigate harmful exposure to said pathogens. The copper medium may comprise first and second copper wool, and a non-copper separator screen disposed therebetween configured to randomize the airflow flowing therebetween. The base filter portion may further comprise a frame that supports a periphery of the pathogen deactivation filter portion, the frame comprising channel portions that cooperatively form a retention channel. The particulate filter is configured to filter particulates from the air stream, and is removably slidably received within the retention channel such that it extends over the pathogen deactivation filter portion.

### TECHNICAL FIELD

The present disclosure relates generally to air filtration devices. More specifically, but not exclusively, the present disclosure relates to air filtration devices including or comprised of a copper, or copper alloy, medium that filter particulate from the air and inactivate airborne pathogens (e.g., viruses, bacteria, coronaviruses, COVID-19, etc.) and mitigate harmful exposure to said pathogens.

### BACKGROUND

The global pandemic caused by an infectious novel coronavirus 2019-nCOV (COVID-19) has been rapidly spreading since December 2019. As of April 2020, the outbreak has spread to over 210 countries, with over 2.4 million confirmed cases and over 170,000 deaths. COVID-19 is a respiratory pathogen where novel methods to mitigate transmission are required to deter the harmful effects of the pandemic. For a comprehensive review of COVID-19, see The American Journal of the Medical Sciences (Volume 360, Issue 1, ISSN 0002-9629) (2020), A Comprehensive Review of Manifestations of Novel Coronaviruses in the Context of Deadly COVID-19 Pandemic, A. Gulati, C. Pomeranz, Z. Qamar, S. Thomas, D. Frisch, G. George, R. Summer, J. DeSimone, B. Sundaram, available at http://www.sciencedirect.com/science/article/pii/S0002962920301798.

Copper is a metal element with atomic symbol Cu that occurs naturally throughout the environment. Copper has established antimicrobial properties that are effective against bacteria, fungi, and virus infections. Various studies have been conducted regarding the antimicrobial properties of copper. Research article Contact Killing and Antimicrobial Properties of Copper provides a comprehensive summary of copper as a metallic antimicrobial agent. See Journal of Applied Microbiology (ISSN 1364-5072), Contact Killing and Antimicrobial Properties of Copper (Sep. 17, 2017), M. Vincent, R. E. Duval, P. Hartemann, M. Engels-Deutsch.

Heating, ventilation, and air conditioning (HVAC) systems regulate indoor environments. HVAC systems, in pertinent part, maintain acceptable indoor air quality through ventilation. Ventilation is the process of exchanging air in any space to provide high quality air involving temperature and/or humidity control, oxygen replenishment, and the removal of harmful bacteria. HVAC systems are equipped with air filtering systems to provide a semblance of purified air to occupants indoors. HVAC systems incorporate one or more filters to remove particles from the air that passes through the filter. Typically, high-efficiency particulate air (HEPA) filters are employed in ventilation systems. HEPA filters are mechanical air filters, which are operable to remove airborne particles with a size of 0.3 microns (μm), and even smaller airborne particles such as 0.1 microns (μm) or lower, to purify air and mitigate the risk of indoor air contamination with particles. Most HEPA filters are about 5 inches thick. Many HEPA filters are not pleated. HEPA filters require periodic cleaning and/or replacement to function properly. However, typical residential HVAC systems include a filter slot, cavity or housing that is configured to house a filter that is about 1 inch thick, and therefore do not accept typical HEPA filters.

While certain aspects of conventional technologies have been discussed to facilitate disclosure of Applicant's inventions, the Applicant in no way disclaims these technical aspects, and it is contemplated that the inventions may encompass one or more conventional technical aspects.

In this disclosure, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

The present inventions may address one or more of the problems and deficiencies of current air filters, air filter systems and related air filtering methods. However, it is contemplated that the inventions may prove useful in addressing other problems and deficiencies in a number of technical areas. Therefore, the claimed invention(s) should not necessarily be construed as limited to addressing any of the particular problems or deficiencies discussed herein.

The present disclosure is directed towards air filtration devices having or comprised of copper screens or wool to inactivate airborne pathogens (e.g., viruses, bacteria, coronaviruses, COVID-19, etc.) and mitigate harmful exposure to airborne pathogens. As used herein, the term copper screen(s) or wool or copper wool/screen material includes, but not limited to, one or more copper screens of any mesh size, copper coated filter papers, copper coated foam, copper foam, a bundle of copper filaments, copper coated cloths, copper or copper coated any other material (such as steel, aluminum, etc.) screens or structures. Copper coating can be by electroless or electroplating, flame spraying, chemical vapor deposition (CVD), sputtering, vacuum deposition or evaporation coating. The term copper also includes all copper alloys listed in Table 1 herein, which are recognized by EPA (Environmental Protection Agency of U.S. Government) as having antimicrobial properties.

In one aspect, the present disclosure is directed to an air filter to inactivate airborne pathogens (e.g., viruses, bacteria, coronaviruses, COVID-19, etc.) in an air stream flowing therethrough. The air filter includes a copper wool medium configured to inactivate pathogens from the air stream flowing therethrough. The copper wool medium is porous and includes or comprised of one or more copper or copper alloys with antimicrobial properties. A frame including or comprised of a rigid or semi-rigid material is configured to support and direct the air stream through the copper wool medium. The frame may be configured to be installed within a filter slot, cavity or housing of a ventilation system (e.g., a heating and/or ventilation and/or air conditioning system (HVAC system), such as a typical residential or commercial HVAC system).

In another aspect, the present disclosure provides an air filter system configured to filter an air stream and inactivate pathogens within the air stream. The air filter system comprises a base filter portion and a particulate filter. The base filter portion comprises a pathogen deactivation filter portion that comprises: a first copper wool medium configured to inactivate viruses from the air stream flowing therethrough; a second copper wool medium configured to inactivate viruses from the air stream flowing therethrough; and a non-copper separator screen disposed between the first copper wool medium and the second copper wool medium configured to randomize the airflow coming out of the first copper wool medium and into the second copper wool medium rather than filter the airflow. The base filter portion further comprises a frame supporting a peripheral portion of a back side of the pathogen deactivation filter portion, the frame comprising channel portions on a front side of the frame that cooperatively form a retention channel that is open at a first end of the pathogen deactivation filter portion. The particulate filter is positioned within the retention channel and extends over a front side of the pathogen deactivation filter portion, the particulate filter being configured to filter particulates from the air stream flowing therethrough. A first end of the frame is void of the channel portions such that the retention channel is open at the first end and the particulate filter is removably slidably received within the retention channel.

In some embodiments, the degree of obstruction that the air filter imparts on the air stream flowing therethrough does not result in a significant increase in pressure drop. In some such embodiments, the air filter system imparts a pressure drop of the air stream flowing therethrough of less 0.6 inches of water. In some such embodiments, the air filter system imparts a pressure drop of the air stream flowing therethrough of less 0.35 inches of water. In some embodiments, the air filter system comprises a minimum efficiency reporting value of the air stream flowing therethrough of at least 8 MERV.

In some embodiments, the first copper wool medium and the second copper wool medium each have a porosity of less than or equal to 3 μm. In some embodiments, the first copper wool medium and the second copper wool medium each impart a pressure drop on the air stream flowing therethrough of less than 0.30 inches of water. In some embodiments, the first copper wool medium and the second copper wool medium each comprise a mesh screen of at least 250 mesh. In some embodiments, the first copper wool medium and the second copper wool medium each comprise a mesh screen of at least 400 mesh. In some embodiments, the first copper wool medium and the second copper wool medium are each configured to inactivate coronaviruses from the air stream flowing therethrough. In some embodiments, the first copper wool medium and the second copper wool medium each comprise one or more copper or copper alloys with antimicrobial properties.

In some embodiments, the pathogen deactivation filter portion further comprises a first non-copper randomizing screen extending over a front side of the first copper wool medium, the first copper wool medium being positioned between the first non-copper randomizing screen and the non-copper separator screen. In such some embodiments, the pathogen deactivation filter portion further comprises a support screen extending over a back side of the second copper wool medium, the second copper wool medium being positioned between the support screen and the non-copper separator screen.

In some embodiments, the channel portions extend from front face portions of the frame and inwardly toward an interior of the frame such that the retention channel is formed between the front face portions and the channel portions. In some such embodiments, the channel portions are L-shaped.

In some embodiments, the frame comprises a pair of opposing sides and a pair of opposing ends, and the channel portions extend along the opposing sides and a second end of the opposing ends. In some such embodiments, the base filter portion defines a thickness that is about 1 inch or less, and wherein the particulate filter defines a thickness that is about ½ inch or less. In some such embodiments, the pair of opposing sides and the pair of opposing ends are configured such that the base filter portion is of a rectangular shape, wherein the particulate filter is of a rectangular shape.

In some embodiments, the particulate filter is a pleated air filter with a minimum efficiency reporting value of the air stream flowing therethrough of at least 5 MERV.

In some embodiments, the particulate filter is a pleated air filter with a minimum efficiency reporting value of the air stream flowing therethrough of at least 5 MERV.

In another aspect, the present disclosure provides a method for removing and deactivating/inactivating airborne pathogens from an air flow. The method comprises obtaining or providing a pathogen deactivation filter configured to deactivate pathogens contained with an air stream flowing therethrough. The pathogen deactivation filter comprises: a first copper wool medium configured to inactivate viruses from the air stream flowing therethrough; a second copper wool medium configured to inactivate viruses from the air stream flowing therethrough; a non-copper separator screen disposed between the first copper wool medium and the second copper wool medium configured to randomize the airflow coming out of the first copper wool medium and into the second copper wool medium rather than filter the airflow; and a frame supporting a peripheral portion of a back side of the pathogen deactivation filter portion, the frame comprising channel portions on a front side of the frame that cooperatively form a retention channel that is open at a first end of the pathogen deactivation filter portion. A first end of the frame is void of the channel portions such that the retention channel is open at the first end. The method further comprises obtaining or providing a particulate filter configured to filter particulates from an air stream flowing therethrough with minimum efficiency reporting value of at least 5 MERV. The method also comprises removably assembling the particulate filter and the pathogen deactivation filter by slidably receiving the particulate filter within the retention channel from the first end such that the particulate filter extends over a front side of the pathogen deactivation filter portion. The method further comprises directing an air stream through the assembled particulate filter and the pathogen deactivation filter.

In some embodiments, directing an air stream through the assembled particulate filter and the pathogen deactivation filter comprises positioning the assembled particulate filter and the pathogen deactivation filter in a duct of an HVAC system, such as via a filter slot or cavity of an HVAC system.

In some embodiments, the pathogen deactivation filter may be a pathogen deactivation filter as described above. In some embodiments, the particulate filter may be a particulate filter as described above.

### BRIEF DESCRIPTION OF THE DRAWINGS

These and other features, aspects, and advantages of the present disclosure will become better understood when the following detailed description is read with reference to the accompanying drawings, which are not necessarily drawn to scale and in which like reference numerals represent like aspects throughout the drawings, wherein:

FIG. 1 depicts a to perspective view of an air filter system, according to an embodiment of the present disclosure.

FIG. 2 depicts a bottom perspective view of the air filter system of FIG. 1, according to an embodiment of the present disclosure.

FIG. 3 depicts a top view of the air filter system of FIG. 1, according to an embodiment of the present disclosure.

FIG. 4 depicts a bottom view of the air filter system of FIG. 1, according to an embodiment of the present disclosure.

FIG. 5 depicts an elevated bottom assembly side perspective view of the air filter system of FIG. 1, according to an embodiment of the present disclosure.

FIG. 6 depicts an elevated bottom assembly end perspective view of the air filter system of FIG. 1, according to an embodiment of the present disclosure.

FIG. 7 depicts an end view of the air filter system of FIG. 1, according to an embodiment of the present disclosure.

FIG. 8 depicts an end cross-sectional view of the air filter system of FIG. 1, according to an embodiment of the present disclosure.

FIG. 9 depicts a top perspective partially-disassembled view of the air filter system of FIG. 1, according to an embodiment of the present disclosure.

FIG. 10 depicts a top perspective view of the base filter portion of the air filter system of FIG. 1, according to an embodiment of the present disclosure.

FIG. 11 depicts an elevated end perspective view of the base filter portion of FIG. 10, according to an embodiment of the present disclosure.

FIG. 12 depicts an enlarge partial end perspective view of the base filter portion of FIG. 10, according to an embodiment of the present disclosure.

FIG. 13 depicts an exploded perspective view of the base filter portion of FIG. 10, according to an embodiment of the present disclosure.

FIG. 14 depicts a bottom view of the particulate filter portion of the air filter system of FIG. 1, according to an embodiment of the present disclosure.

FIG. 15 depicts a top view of the particulate filter portion of FIG. 14, according to an embodiment of the present disclosure.

FIG. 16 depicts an exploded assembly view of the particulate filter portion of FIG. 14, according to an embodiment of the present disclosure.

FIG. 17 depicts an exploded side view of an alternative air filter system, according to an embodiment of the present disclosure.

FIG. 18 depicts a flow chart of a method for removing and deactivating/inactivating airborne pathogens from an air flow, according to an embodiment of the present disclosure.

### DETAILED DESCRIPTION

Aspects of the present disclosure and certain examples, features, advantages, and details thereof, are explained more fully below with reference to the non-limiting examples illustrated in the accompanying drawings. Descriptions of well-known materials, features, aspects, components, fabrication, processing techniques, etc., may be omitted so as not to unnecessarily obscure the relevant details. It should be understood, however, that the detailed description and the specific examples, while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art from this disclosure.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. In some instances, the approximating language may correspond to the precision of an instrument for measuring the value.

Terminology used herein is for the purpose of describing particular examples only and is not intended to be limiting. As used herein, references to “one example”, “one embodiment” and “an embodiment” (and the like) are not intended to be interpreted as excluding the existence of additional examples that also incorporate one or more of recited features, or examples that do not incorporate one or more of recited features.

As used herein, the terms “member” and “portion” may include multiple sub-portions that may be of the same or differing materials, and/or may be a part or fraction of a piece, component or feature or the entirety of the piece, component or feature. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

Generally stated, the present disclosure is directed to air filtration devices having or comprised of copper wool. The antimicrobial properties of copper and the unique structural conformation of copper wool may be useful to inactivate airborne pathogens (e.g., viruses, bacteria, coronaviruses, COVID-19, etc.) in an air stream flowing through the air filtration devices to mitigate the risk of harmful exposure to airborne pathogens (e.g., mitigate the risk of COVID-19 transmission). An air filtration device includes, but is not limited to, air filters for ventilation systems. The present disclosure is applicable in homes, hotels and motel rooms, small restaurants/bars, stores, small business facilities, workplaces, and other residential, commercial, and business locations, etc. As used herein, the term copper wool or copper wool material includes, but not limited to, one or more copper screens of any mesh size, copper coated filter papers, copper coated foam, copper foam, a bundle of copper filaments, copper coated cloths, copper or copper coated any other material (such as steel, aluminum, etc.) screens or structures. Copper coating can be by electroless or electroplating, flame spraying, chemical vapor deposition (CVD), sputtering, vacuum deposition or evaporation coating. The term copper also includes all copper alloys listed in Table 1 herein, which are recognized by EPA (Environmental Protection Agency of U.S. Government) as having antimicrobial properties.

Embodiments of the present disclosure may include or be comprised of material that may “inactivate” or “deactivate” (used synonymously herein) pathogens within an air stream, such as viruses. Pathogen inactivation selectively damages genetic material that prevents the pathogen (e.g., viruses, bacteria, and parasites) from transmitting infection, often due to an inability to replicate DNA and/or RNA. The inactivation of viruses may occur through the interaction of metallic ions (e.g., Cu⁺ and Cu²⁺) that bond with a virus. For example, an air stream having or comprised of COVID-19 particles is directed through a porous copper wool medium. COVID-19 particles encounter the porous copper wool medium and, thus, encounter metallic ions in the vicinity. The interaction between the porous copper wool medium and COVID-19 particles results in an inactive state of COVID-19, wherein the inactive state of COVID-19 is unable to replicate in an organism that is unaffected by COVID-19.

Embodiments of the present disclosure include or are comprised of copper or copper alloy products with antimicrobial properties useful to inactivate pathogens (e.g., viruses, bacteria, coronaviruses, COVID-19, etc.). Table 1 provides a list of the Unified Number System (UNS) designations for 510 copper and copper alloy products registered with Environmental Protection Agency (EPA) determined to have antimicrobial properties. The UNS is the accepted alloy designation system in North America for wrought and cast copper and copper alloy products. Embodiments of the present disclosure may include one or more of the identified copper or copper alloy products referenced in Table 1. The copper and copper alloys identified in Table 1 may hereinafter be collectively referred to as “Copper Material” (i.e., the term “Copper Material” refers to one or more of the identified coppers and copper alloys identified in Table 1).

TABLE 1
EPA Registered Antimicrobial Copper Alloys (UNS Numbers)

| | A | B | C | D | E | F | G | H |
|---|---|---|---|---|---|---|---|---|
| 1 | C10100 | C14750 | C19260 | C43000 | C61200 | C66430 | C71600 | C87800 |
| 2 | C10200 | C15000 | C19280 | C43400 | C61300 | C66500 | C71630 | C87845 |
| 3 | C10300 | C15100 | C19300 | C43500 | C61400 | C66700 | C71640 | C87850 |
| 4 | C10400 | C15150 | C19400 | C43600 | C61500 | C66850 | C71700 | C87860 |
| 5 | C10500 | C15500 | C19410 | C43800 | C61550 | C66900 | C72500 | C87870 |
| 6 | C10700 | C15600 | C19419 | C44200 | C61600 | C66908 | C72600 | C89320 |
| 7 | C10800 | C15650 | C19450 | C44250 | C61700 | C66910 | C72650 | C89510 |
| 8 | C10900 | C15710 | C19500 | C44300 | C61800 | C66913 | C72660 | C89520 |
| 9 | C10910 | C15715 | C19600 | C44400 | C61810 | C66915 | C72700 | C89537 |
| 10 | C10920 | C15720 | C19700 | C44500 | C61900 | C66920 | C72800 | C89550 |
| 11 | C10930 | C15725 | C19710 | C44750 | C62000 | C66925 | C72900 | C89560 |
| 12 | C10940 | C15730 | C19720 | C45450 | C62200 | C66930 | C72950 | C89570 |
| 13 | C11000 | C15735 | C19750 | C45470 | C62300 | C66950 | C73100 | C89580 |
| 14 | C11010 | C15750 | C19800 | C46210 | C62400 | C68300 | C73200 | C89720 |
| 15 | C11020 | C15760 | C19810 | C46250 | C62500 | C68350 | C73500 | C89833 |
| 16 | C11025 | C15780 | C19900 | C49250 | C62580 | C68400 | C73800 | C89835 |
| 17 | C11030 | C15790 | C19910 | C49260 | C62581 | C68410 | C74000 | C89842 |
| 18 | C11040 | C15815 | C20500 | C49300 | C62582 | C68700 | C74300 | C89845 |
| 19 | C11045 | C15900 | C21000 | C49340 | C62600 | C68800 | C74400 | C89940 |
| 20 | C11100 | C16200 | C22000 | C49350 | C62730 | C68900 | C74500 | C90280 |
| 21 | C11300 | C16210 | C22600 | C49355 | C62800 | C69000 | C75200 | C90400 |
| 22 | C11400 | C16400 | C23000 | C49360 | C63000 | C69050 | C75700 | C90410 |
| 23 | C11500 | C16500 | C23030 | C50100 | C63010 | C69100 | C75720 | C90420 |
| 24 | C11600 | C17000 | C23400 | C50150 | C63020 | C69150 | C76400 | C90430 |
| 25 | C11700 | C17200 | C24000 | C50200 | C63200 | C69200 | C80100 | C94700 |
| 26 | C11900 | C17400 | C25000 | C50500 | C63230 | C69220 | C80300 | C95200 |
| 27 | C11904 | C17410 | C25600 | C50510 | C63280 | C69230 | C80410 | C95210 |
| 28 | C11905 | C17420 | C26000 | C50580 | C63300 | C69250 | C80500 | C95220 |
| 29 | C11907 | C17450 | C26100 | C50590 | C63380 | C69300 | C80700 | C95300 |
| 30 | C12000 | C17460 | C26130 | C50700 | C63400 | C69310 | C80900 | C95400 |
| 31 | C12100 | C17500 | C26200 | C50705 | C63700 | C70100 | C81100 | C95410 |
| 32 | C12200 | C17510 | C26800 | C50710 | C63800 | C70200 | C81200 | C95420 |
| 33 | C12210 | C17520 | C27000 | C50715 | C63900 | C70230 | C81300 | C95430 |
| 34 | C12220 | C17530 | C27200 | C50725 | C64200 | C70240 | C81700 | C95500 |
| 35 | C12300 | C17600 | C27400 | C50780 | C64210 | C70250 | C81800 | C95510 |
| 36 | C12500 | C17700 | C28000 | C50800 | C64250 | C70252 | C82000 | C95520 |
| 37 | C12510 | C18620 | C28300 | C50900 | C64400 | C70260 | C82100 | C95600 |
| 38 | C12700 | C18625 | C28310 | C51000 | C64700 | C70265 | C82200 | C95700 |
| 39 | C12800 | C18660 | C28320 | C51080 | C64710 | C70270 | C82400 | C95710 |
| 40 | C12900 | C18661 | C28330 | C51100 | C64720 | C70275 | C82500 | C95720 |
| 41 | C13100 | C18665 | C40400 | C51180 | C64725 | C70280 | C82510 | C95800 |
| 42 | C13150 | C18835 | C40410 | C51190 | C64727 | C70290 | C82600 | C95810 |
| 43 | C13400 | C18900 | C40500 | C51800 | C64728 | C70300 | C82700 | C95820 |
| 44 | C13500 | C18910 | C40800 | C51900 | C64730 | C70310 | C82800 | C95900 |
| 45 | C13600 | C18980 | C40810 | C51980 | C64740 | C70350 | C83460 | C96200 |
| 46 | C13700 | C19000 | C40820 | C52100 | C64745 | C70370 | C83470 | C96300 |
| 47 | C14180 | C19002 | C40850 | C52180 | C64750 | C70400 | C84000 | C96400 |
| 48 | C14181 | C19010 | C40860 | C52400 | C64760 | C70500 | C84010 | C96600 |
| 49 | C14200 | C19015 | C40950 | C52480 | C64770 | C70600 | C84020 | C96700 |
| 50 | C14210 | C19020 | C41000 | C52600 | C64780 | C70610 | C84030 | C96800 |
| 51 | C14300 | C19022 | C41100 | C52900 | C64785 | C70620 | C85450 | C96900 |
| 52 | C14310 | C19024 | C41110 | C55180 | C64800 | C70690 | C85470 | C96950 |
| 53 | C14400 | C19025 | C41120 | C55181 | C64900 | C70700 | C85550 | C96970 |
| 54 | C14410 | C19027 | C41125 | C55280 | C65100 | C70800 | C85900 | C99300 |
| 55 | C14415 | C19030 | C41300 | C55281 | C65300 | C70900 | C85910 | C99400 |
| 56 | C14420 | C19040 | C41500 | C55282 | C65500 | C71000 | C85920 | C99500 |
| 57 | C14430 | C19050 | C42000 | C55283 | C65600 | C71100 | C85930 | C99710 |
| 58 | C14440 | C19170 | C42100 | C55284 | C65620 | C71110 | C86350 | C99760 |
| 59 | C14500 | C19200 | C42200 | C55285 | C65800 | C71300 | C87300 | C99761 |
| 60 | C14510 | C19210 | C42210 | C55385 | C66200 | C71500 | C87500 | C99770 |
| 61 | C14520 | C19215 | C42220 | C55386 | C66300 | C71520 | C87600 | C99771 |
| 62 | C14530 | C19220 | C42500 | C60600 | C66400 | C71580 | C87610 | C99780 |
| 63 | C14700 | C19240 | C42520 | C60700 | C66410 | C71581 | C87700 | |
| 64 | C14710 | C19250 | C42600 | C61000 | C66420 | C71590 | C87710 | |

Embodiments of the present disclosure pertaining to an air filter to inactivate airborne pathogens (e.g., viruses, bacteria, coronaviruses, COVID-19, etc.) in an air stream flowing therethrough may include or be comprised of one or more of the following: (i) one or more copper wool layers having or comprised of Copper Material; (ii) one or more mesh layers having or comprised of Copper Material; (iii) two or more layers, where at least one layer having or is comprised of Copper Material; (iv) Copper Material nanoparticles; (v) textile fibers having or comprised of Copper Material; (vi) textile fibers having or comprised of Copper Material nanoparticles; (vii) a copper wool layer with a porosity less than 10μ; (viii) a copper wool layer with a porosity greater than 0.125μ; (ix) Copper Material powder; (x) a copper wool medium with antimicrobial properties, (xi) a copper wool layer having or comprised of Copper Material positioned on an outer surface/side of the layer; (xii) a copper wool layer having or comprised of Copper Material positioned on an inner surface/side of the layer; (xiii) a detachable copper wool layer having or comprised of Copper Material; (xiv) Copper Material nanoparticles; (xv) Copper Material powder; (xvi) textiles having or comprised of Copper Material; (xvii) textile having or comprised of Copper Material nanoparticles; and (xviii) such configurations with other metals or materials which may have higher resistance to develop a surface coating due to exposure to atmospheric conditions.

In some embodiments, the present disclosure may include or be comprised of a “conventional particulate filer/air filter” or “particulate air filter.” A “conventional particulate filer/air filter” or “particulate air filter” refers to a filtration device or material that is used in existing ventilation system to remove particles from air streams to increase the quality of the air. Conventional particulate air filters may include, but is not limited to, one or more of the following: (i) high-efficiency particulate air (HEPA) filters; (ii) fiberglass filters; (iii) pleated air filters; and (iv) any other material, or combination of material, that is presently utilized to purify an air stream flowing therethrough. It is noted that the present disclosure may include a “particulate air filter” which may be formed or comprised of conventional filtering materials and construction, but that is configured specifically for the air filter systems disclosed herein. For example, a “particulate air filter” may include a thickness of about 1 inch or greater or about 3 inches or greater, which is thereby configured to be retained/housed within a corresponding filter slot or cavity of an HVAC system or duct. In the present disclosure, a “particulate air filter” may include a thickness less than about 3 inches or less than about 1 inch, such as about ½ inch, so that the particulate air filter can be assembled with a pathogen deactivation filter, and the assembly define a thickness that is compatible with conventional HVAC systems (such as the assembly defining a thickness of about 1 inch or about 3 inches to such that the assembly fits within a filter slot or cavity of an HVAC system or duct).

In some embodiments, an air filter to inactivate airborne pathogens (e.g., viruses, bacteria, coronaviruses, COVID-19, etc.) in an air stream flowing therethrough may include or be comprised of at least a first layer and a second layer, wherein the first layer is a conventional particulate air filter which removes or traps particles/particulates based upon size, such as a pleated particulate filter, and the second layer is copper-including pathogen deactivation filter which functions to inactivate airborne pathogens. The first layer and second layer may be held together by a frame. The frame may removably couple the particulate filter and the pathogen deactivation filter, and be configured such that the construct may be positioned within a HVAC system (e.g., within a filter avert or slot thereof) such that the second layer is downstream of the first layer.

Alternatively, the first layer (e.g., a particulate air filter) and the second layer (e.g., copper-including pathogen deactivation filter) may be stacked and held together by an adhesive. As another alternative example, the particulate air filter and the copper-including pathogen deactivation filter may be removably coupled via an external frame or sleeve that is separate and distinct from the particulate air filter and the pathogen deactivation filter. In some other alternative embodiments, the particulate air filter and the pathogen deactivation filter may be fixedly coupled together such that the particulate air filter cannot be decoupled from the pathogen deactivation and replaced by a new/clean replacement or supplemental particulate air filter.

In some embodiments, the pathogen deactivation filter portion of an air filter system according to the present disclosure may include or is comprised of at least one copper wool medium with a first porosity. The at least one copper wool medium may be configured such that a flowing air stream directed through the at least one copper wool medium substantially flows therethrough without a significant change in pressure. The at least one copper wool medium may be configured such that the first porosity enables pathogens (such as coronaviruses) within the flowing air stream to contact, or be in the proximity of, the at least one copper wool medium. The first porosity may range from 0.125 μm to 10 μm. In some embodiments, the at least one copper wool medium (and potentially the pathogen deactivation filter portion as a whole) may have a porosity of less than or equal to 3 μm. In some embodiments, the at least one copper wool medium (and potentially the pathogen deactivation filter portion as a whole) may have a mesh of at least 250 mesh, or a mesh of at least 400 mesh.

For example, a pathogen deactivation filter portion of an air filter system according to the present disclosure may include or comprised of at least one, and more advantageously at least two, copper wool medium with a porosity that is greater than 0.125 μm. COVID-19 particles are approximately 0.125 μm. An air stream includes or comprised of COVID-19 particles is directed through the at least one copper wool medium. The COVID-19 particles directly contact, or come within the proximity of, the at least one copper wool medium. The at least one copper wool medium-due to antimicrobial properties-inactivates the COVID-19 (and other pathogens within the air stream). As such, individuals that breath in air that has passed through the copper wool medium will not result in COVID-19 transmission (and transmission of other pathogens) because the virus particles/pathogens are inactivated/deactivated.

In some embodiments, the air filter system generally and/or the pathogen deactivation filter portion includes or comprised of at least one copper wool medium with a first porosity, wherein the first porosity is 3 μm or greater, and/or of at least 250 mesh or a mesh of at least 400 mesh. An air stream is directed through the at least one copper wool medium with the first porosity. Any pathogen particles within the air stream (i.e., COVID-19 virus particles) are inactivated upon passing through the copper wool medium.

In some embodiments, an air filter including a pathogen deactivation filter portion to inactivate airborne pathogens (e.g., viruses, bacteria, coronaviruses, COVID-19, etc.) in an air stream flowing therethrough includes or comprised of two or more copper wool layers, wherein the two or more copper wool layers includes or are comprised of Copper Material. The two or more copper wool layers may or may or have different porosity values. The two or more copper wool layers are stacked adjacent to each other in the direction of the air flow therebetween and held together. For example, four elongate sides of a frame of the pathogen deactivation filter portion may be positioned on the perimeter of two copper wool layers stacked together. Four corners hold the elongate sides together to provide a rigid frame structure for the pathogen deactivation filter portion (and the filer system as a whole) to be placed in a ventilation system.

In some embodiments, an air filter device including a pathogen deactivation filter portion to inactivate airborne pathogens (e.g., viruses, bacteria, coronaviruses, COVID-19, etc.) in an air stream flowing therethrough may include or be comprised of three layers. A first layer may include or be comprised of copper wool with a first porosity; a second layer may include or be comprised of a copper wool with a second porosity; and a third separator air flow randomizing layer that is positioned between the first and second copper wool layers. The three layers are aligned and stacked together, and may be held together by mechanical and/or chemical forces (e.g., a frame, adhesive, etc.).

In some embodiments, an air filter device including a pathogen deactivation filter portion to inactivate airborne pathogens (e.g., viruses, bacteria, coronaviruses, COVID-19, etc.) may include or be comprised of at least a first layer of copper wool with a first porosity. A second layer may include or be comprised of Copper Material nanoparticles deposited on at least one surface of the first layer of copper wool. The first layer of copper wool may include or be comprised of the same Copper Material as the second layer of Copper Material nanoparticles. Deposition of Copper Material nanoparticles may occur through any chemical processes. Alternatively, a first layer of copper wool may include or be comprised of a first copper composition and a second layer of nanoparticles may include or be comprised of a second copper composition deposited on the first layer of copper wool.

In some embodiments, an air filter device/system including a pathogen deactivation filter portion to inactivate airborne pathogens (e.g., viruses, bacteria, coronaviruses, COVID-19, etc.) may include or be comprised of two or more layers of copper wool medium with a first density. The first density is approximately 5% to 10% relative to a device having or is comprised of pure copper with substantially similar dimensions. For example, an air filter device/system of the present disclosure may include or be comprised of two or more copper wool screens/wool layers may include dimensions of conventional HVAC air filters, may be about 3 inches thick or less, or about 1 inch thick or less.

In some embodiments, a filter device/system with a pathogen deactivation filter portion configured to inactivate airborne pathogens (e.g., viruses, bacteria, coronaviruses, COVID-19, etc.) according to the present disclosure may include or be comprised of at least a first copper wool medium with a first density and a second copper wool medium with a second density. The first density is approximately 5% to 10% relative to a device having or comprised of pure copper with substantially similar dimensions. The second density is approximately 5% to 10% relative to a device having or comprised of pure copper with substantially similar dimensions. The air filter system is configured to direct an air stream through the pathogen deactivation filter portion (first copper wool medium and second copper wool medium).

In some embodiments, a filter device/system with a pathogen deactivation filter portion configured to inactivate airborne pathogens (e.g., viruses, bacteria, coronaviruses, COVID-19, etc.) according to the present disclosure may include or be comprised of at least two layers of copper wool medium with a separator screen therebetween, and a particulate air filter coupled to the pathogen deactivation filter portion, is configured to obstruct an air stream such that the air stream is formed to flow through the particulate air filter and then through the pathogen deactivation filter portion (or vice versa) such that a majority of particles and/or pathogens within the air stream contact the copper wool medium of the pathogen deactivation filter portion and/or the particulate air filter. The air filter device/system is configured to obstruct the air stream flowing therethrough without a significant change in pressure drop (i.e., the degree of obstruction that the air filter device/system imparts on the air stream flowing therethrough does result in a significant increase in pressure drop or require a change in a circulation system where the air filter device/system is positioned). For example, an air filter device/system with a particulate air filter portion and a pathogen deactivation filter portion (having or comprised of at least two layers of copper wool and a separator screen therebetween) is positioned in a ventilation system and an air stream is directed therethrough. The air stream may include or be comprised of a plurality of air particles (e.g., oxygen, coronaviruses, COVID-19 particles, other non-pathogen particles (e.g., dust), etc.). Most of the air particles, of the plurality of air particles, come into direct contact with the copper screen layers when passing through the air filter device and/or the particulate filter portion. The air filter device/system is configured to enable the flow of the air stream therethrough without a significant drop in pressure. As such, the use of the air filter device/system does not require a change in the operation of air circulation blowers or other equipment used to direct the air stream of an HVAC system.

In some embodiments, a device to inactivate airborne pathogens (e.g., viruses, bacteria, coronaviruses, COVID-19, etc.) flowing therethrough having or comprised of one or more of the following: (i) at least one conventional particulate air filter; (ii) at least two layers of copper mesh/screen; (iii) a separator air flow randomizing/turbulence screen or mech layer between each pair of copper mesh/screen layers; and (iv) a frame structure to removably couple features (i)-(iii) tougher to form an air filter system/device configured to be utilized in conventional HVAC systems.

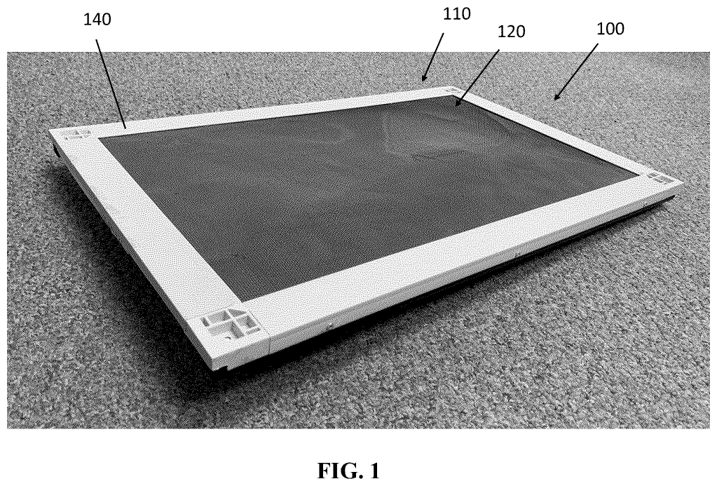

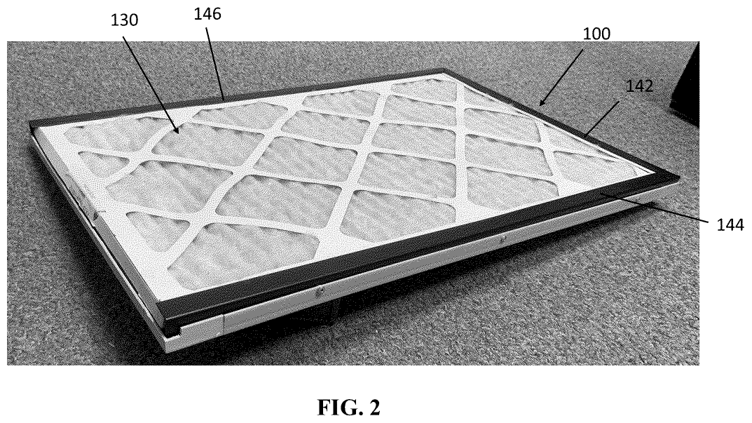

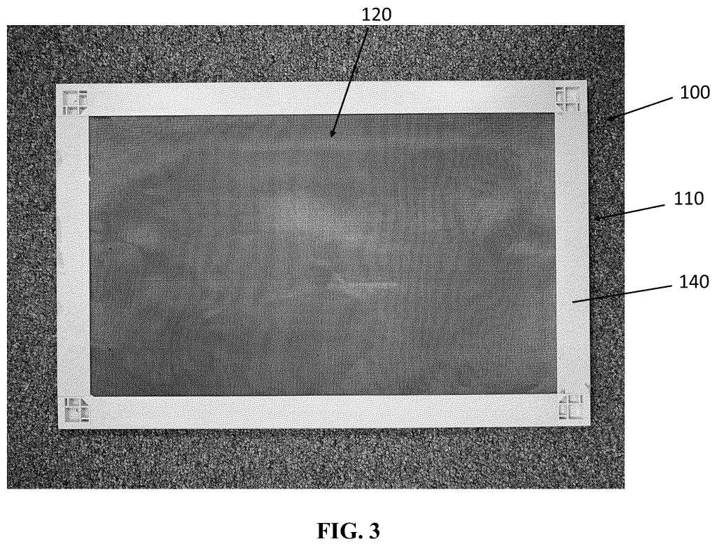

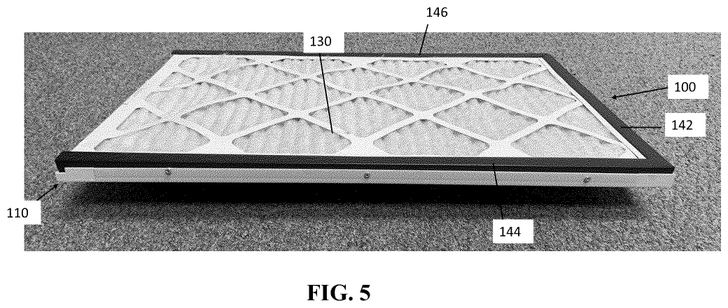

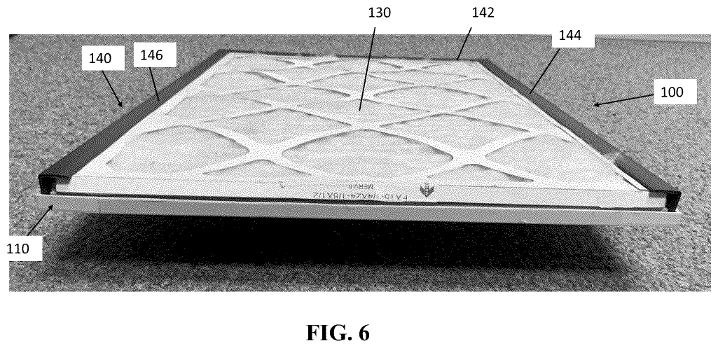

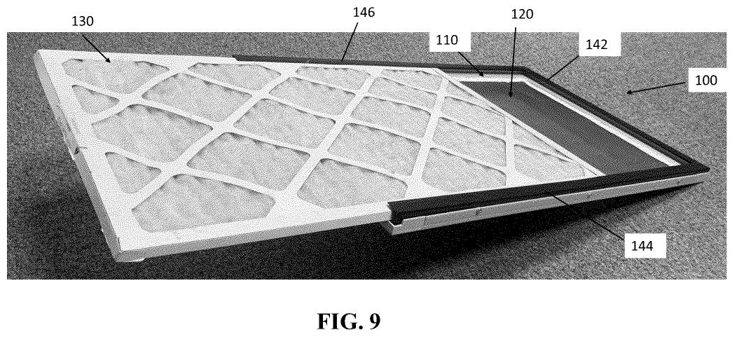

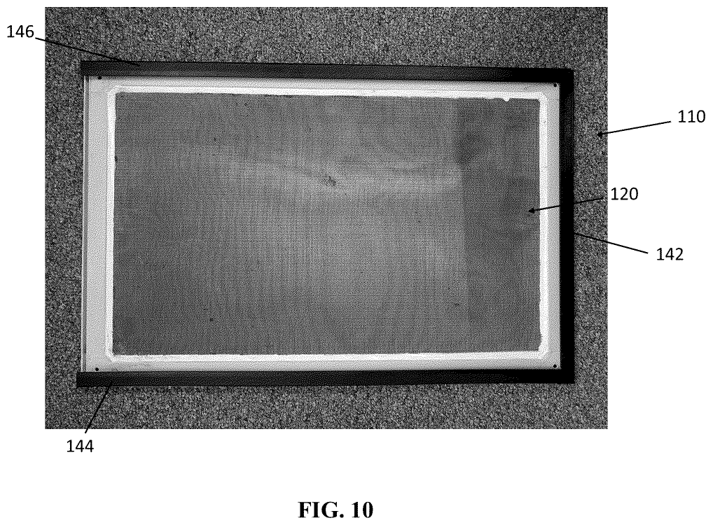

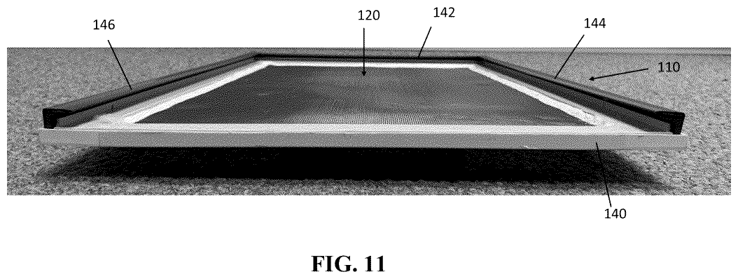

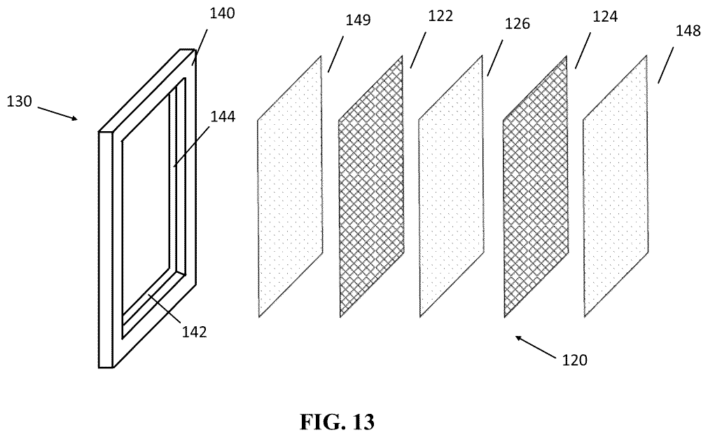

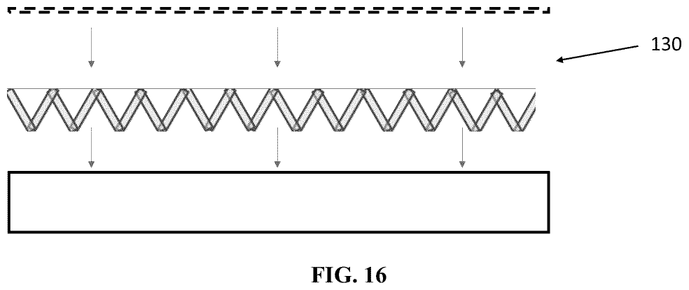

As shown in FIGS. 1-16, in some embodiments, an air filter system 100 according to the present disclosure may be configured to inactivate/deactivate airborne pathogens (e.g., viruses, bacteria, coronaviruses, COVID-19, etc.) and filter particulate of air flowing therethrough. The air filter system 100 may include a particulate filter 130 that is configured to filter general particulate from the air flow, and a pathogen deactivation filter portion 120 that is configured to inactivate/deactivate airborne pathogens from the air flow. The air filter system 100 may include or be comprised of a base filter portion 110, the particulate filter 130, and a frame 140, as shown in FIGS. 1-16.

As shown in FIGS. 1-13, the base filter portion 110 may include or be comprised of a frame 140 and the pathogen deactivation filter portion 120. The frame 140 may border a perimeter or periphery of the pathogen deactivation filter portion 120. The pathogen deactivation filter portion 120 may include or be comprised of a first copper wool medium/screen 122, a second copper wool medium/screen 124, and a separator medium/screen 126 that separates and is located in between first copper mesh screen 122 and second copper mesh screen 124. The separator medium/screen 126 may be non-metallic (e.g., non-copper) or non-electrically conductive. In some other embodiments, the separator medium/screen 126 is metallic.

In some embodiments, the base filter portion 110/pathogen deactivation filter portion 120 may further include a back mesh/screen 148 positioned over a back side of the first copper mesh screen 122, and a front mesh/screen 149 positioned over a front side of the second copper mesh screen 124. The back and front screens 148, 149 may bound the outsides of the first pathogen deactivation filter portion 120, and may aid in retaining the first and second copper screens 122, 124 and the separators screens 126 together in a stacked adjacent relationship and coupled with the other portions of the base filter portion 110.

The first copper mesh screen 122 and the second copper mesh screen 124 may each include or be comprised of copper, or copper alloys, with antimicrobial properties. The first copper mesh screen 122 and the second copper mesh screen 124—due to their antimicrobial properties-inactivate/deactivate pathogens flowing therethrough, as described herein.

The separator screen 126 may diffuse the particles and pathogens passing therethrough in order to increase the efficiency of pathogen deactivation from the second copper screen 124 to the first copper screen 122. In some embodiments, separator screen 126 may be operable to randomize airflow coming out of the second copper mesh screen 124 and into/to the second copper mesh screen 122. The separator screen 126 may be made of a fabric, plastic, metallic, wires, etc. The thickness of the separator screen 126 (and the space between the first and second copper screens 122, 124) may be operable to adequately randomize the flow pattern of air passing through it, e.g., the thickness of the separator screen 126 (and the space between the first and second copper screens 122, 124) may be greater the thicknesses of the first and second copper screens 122, 124 themselves. For example, in some embodiments, the separator screen 126 between the first and second copper screens 122, 124 is made from a material, and physically configured, to produce a randomized air flow pattern of the air exiting out of the second (inner) copper screen 124, such as a turbulent flow or more turbulent flow. This may ensure that even if the holes in the first (outer) copper screen 122 are perfectly aligned with holes in the second (inner) copper screen 124 (a very unlikely possibility), the air exiting out of the second (inner) copper screen 124 may not go through straight out of the first (outer) copper screen 122 without interacting (e.g., contacting or abutting) with the copper material of the first copper screen 122. In some embodiments, the opening or air passageways of the first and second copper screens 122, 124 are not aligned.

Thus, if the first and second copper screens 122, 124 are 400 mesh copper screens, such screens may have 38% open area and hence 62% of the incoming air particles will impact copper in the second screen 124 allowing 38% to pass through without coming in contact with copper. The air coming out of this second (inner) copper screen 124 will be randomized by the separator screen 126 between the first and second copper screens 122, 124. Because the pattern of the air flow of the air coming out of the separator 126 is randomized, at least 62% of this air will impact the copper in the first (outer) copper screen 122. Hence, coronavirus particles and other pathogens exiting from the air filter system 100/pathogen deactivation filter portion 120 will be at most 38%×38%=14.4% of the incoming air. Normal HVAC practice is to recirculate about 80% of the air with 20% fresh air. The amount of coronavirus/pathogens coming out on a second pass through thus would be at most (14.4%×20%+14.4%×14.4%×80%=) 4.6% of the concentration in the fresh air. The amount of coronavirus coming out on a third pass through thus would be at most (14.4%×20%+14.4%×14.4%×14.4%×80%=) 3.2% of the concentration in the fresh air. After few passes the coronavirus level in the conditioned space would be at most 2.9% that of the level in the fresh incoming air. If a lower level is needed, the number of copper screens can be increased and/or the mesh size can be altered.

In some embodiments, the air filter system 100 and/or base filter portion 120/the pathogen deactivation filter portion 120 may be configured to deactivate at least 80% of the pathogens (e.g., viruses, etc.) from an air stream passing therethrough (i.e., per pass). In some embodiments, the air filter system 100 and/or the pathogen deactivation filter portion 120 may be configured to deactivate at least 90% of the pathogens (e.g., viruses, etc.) from an air stream passing therethrough (i.e., per pass). In some embodiments, the air filter system 100 and/or the pathogen deactivation filter portion 120 may be configured to deactivate at least 91% of the pathogens (e.g., viruses, etc.) from an air stream passing therethrough (i.e., per pass).

In some embodiments, the air filter system 100 (i.e., the base filter portion 120 (with the pathogen deactivation filter portion 120) and the particulate filter 130) may be configured such that it comprises a minimum efficiency reporting value of/for the air stream flowing therethrough of at least 5 MERV, or more preferably at least 6 MERV, or more preferably at least 7 MERV, or more preferably at least 8 MERV, or more preferably at least 9 MERV, or more preferably at least 10 MERV, or more preferably at least 11 MERV, or more preferably at least 12MERV, or more preferably at least 13 MERV. In some embodiments, the particulate filter 130 may be configured (e.g., as a conventional pleated air filter) such that it comprises a minimum efficiency reporting value of/for the air stream flowing therethrough of at least 3 MERV, or more preferably at least 4 MERV, or more preferably at least 5 MERV, or more preferably at least 6 MERV, or more preferably at least 7 MERV, or more preferably at least 8 MERV.

In some embodiments, the air filter system 100 (i.e., the base filter portion 120 (with the pathogen deactivation filter portion 120) and the particulate filter 130) may be configured such that it imparts a pressure drop of the air stream flowing therethrough of less than about 0.6 inches of water, or more preferably of less than about 0.5 inches of water, or of less than about 0.4 inches of water, or of less than about 0.35 inches of water, or of less than about 0.3 inches of water. In some embodiments, the base filter portion 120 (specifically, the pathogen deactivation filter portion 120) of less than about 0.4 inches of water, or of than about less 0.35 inches of water, or of less than about 0.3 inches of water.

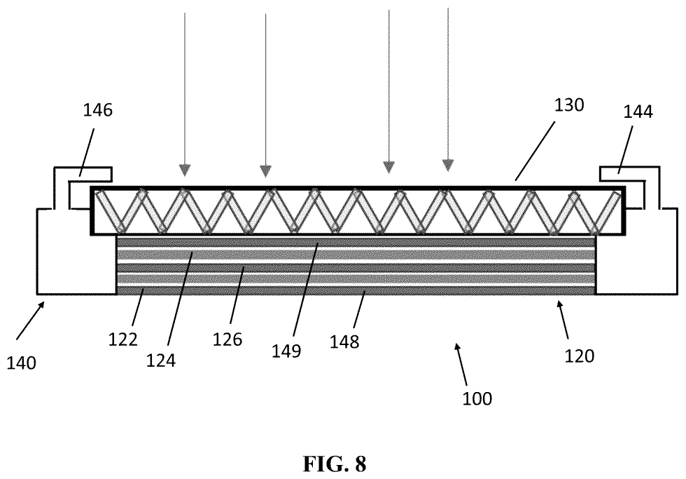

As shown in FIGS. 1-14, the pathogen deactivation filter portion 120 is positioned within and affixed to the frame 140. Pathogen deactivation filter portion 120 may be fixed within the top and bottom surfaces of base filter portion 120 and/or to/with the frame 140 through tape, glue, screws, and/or other means. In some embodiments, the pathogen deactivation filter portion 120 is coupled to a recess of the frame 140, as shown in FIG. 8. In some embodiments, the pathogen deactivation filter portion 120 is positioned and retained within a channel, groove or slot such that the frame extends over front and back peripherical portions of the pathogen deactivation filter portion 120.

The frame 140 may support a peripheral portion of a back side of the pathogen deactivation filter portion 120. The frame 140 may include a or may be comprised of a set of channels or channel portions that extend from a front side/face of the frame that form an open inner end or side that allows the particulate filter 130 to be slotted into the base portion 110/frame 140 and removably coupled with the pathogen deactivation filter portion 120, to thereby form the air filter system 100 by joining the base filter portion 110 and the particulate filter 130.

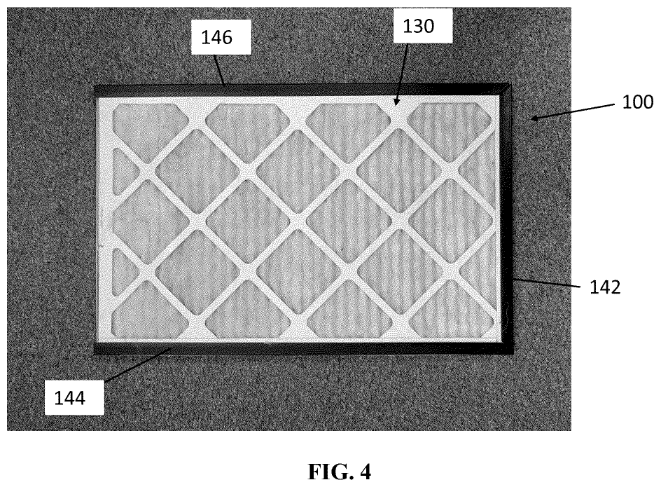

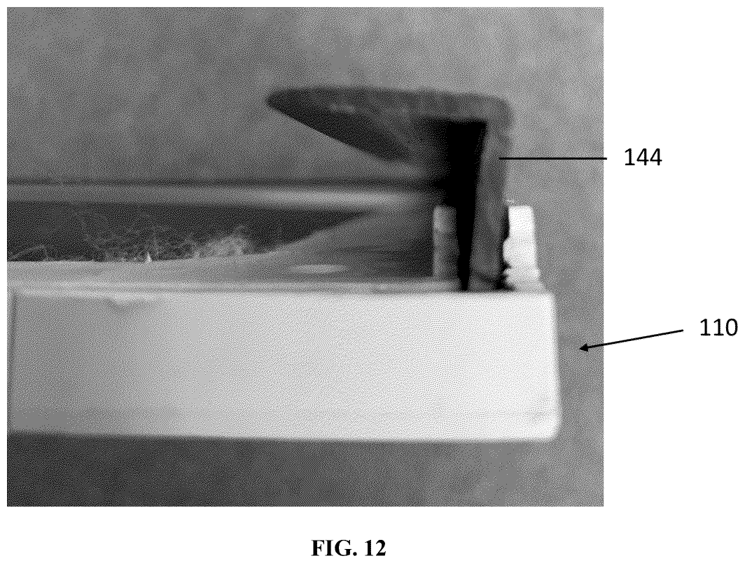

In some embodiments, the frame 140 may include a front end channel portion 142 with a recess cross-sectional shape (see FIG. 12) that connects to a front first side channel portion 144 and a front second side channel portion 146 that each include the recess cross-sectional shape, as shown in FIGS. 4-13. The channel portions of the frame 140 may thereby extend only partially about the periphery or border portion of the pathogen deactivation filter portion 120 such that one end or side of the frame 140/pathogen deactivation filter portion 120/base filter portion 110 is open to allow/accommodate a particulate filter 130 to releasably insert into a cavity bounded on its sides by the first side frame channel portion 144, the second side frame channel portion 146, the front side frame channel portion 142 and a front side of the frame 140. The frame 140 may thereby comprise channel portions 142, 144, 146 on a front side of the frame that cooperatively form a retention channel that is open at a first end of the pathogen deactivation filter portion 120. A first end of the frame 140 may thereby be void of the channel portions 142, 144, 146 such that the retention channel is open at the first end of the frame 140/pathogen deactivation filter portion 120/base filter portion 110 and a particulate filter 130 can be removably slidably received within the retention channel, as shown in FIGS. 4-9. A particulate filter 130 may thus be positioned within the retention channel and extend over a front side of the pathogen deactivation filter portion 130, as shown in FIGS. 1-9.

As shown in FIGS. 1-13, in some embodiments, the channel portions 142, 144, 146 extend from front face portions of the frame 140 and inwardly toward an interior of the frame 140 such that the retention channel is formed between the front face portions and the channel portions 142, 144, 146. The interior of the frame 140 include or defines a through hole, opening or aperture to allow an air flow to flow therethrough, which is covered by or contains the pathogen deactivation filter portion 120 thereover/therein. In some such embodiments, the channel portions 142, 144, 146 are L-shaped, as shown in FIG. 12. As noted above, the frame 140 may comprise a pair of opposing sides and a pair of opposing ends, and the channel portions 142, 144, 146 may extend along the opposing sides and a second end of the opposing ends, but not along the first end such that the first end is void of a channel portion and allows the particulate filter 130 to slid into/out from the retention channel, but secures the particulate filter 130 to the base filter portion 110/pathogen deactivation filter portion 120 when the particulate filter 130 is positioned within the retention channel, as shown in FIGS. 1-13.

In the illustrated exemplary (non-limiting) embodiment, the frame 140, the pathogen deactivation filter portion 120 (and thus the base filter portion 110) and the particulate filter 130 are rectangular, and the perimeter of frame 140 is slightly greater than the perimeter of the pathogen deactivation filter portion 120, and the perimeter of frame 140 and the retention channel is slightly greater than the perimeter of the particulate filter 130. In some other embodiments, the frame 140, the pathogen deactivation filter portion 120 (and thus the base filter portion 110) and the particulate filter 130 may have different shapes to accommodate the dimensions of a given air ventilation system. For example, the frame 140, the pathogen deactivation filter portion 120 (and thus the base filter portion 110) and the particulate filter 130 may be circular.

In some embodiments, the pathogen deactivation filter portion 120 may include or be comprised of two or more screens, wools or meshes formed of copper, or copper alloys, with antimicrobial properties. For example, the pathogen deactivation filter portion 120 may include or be comprised of a combination of UNS #C10100 and C10200. In some embodiments, the pathogen deactivation filter portion 120 may include or be comprised of two or more layers of copper wool. The two or more layers of copper wool/screen/mesh may further include or be comprised of at least one copper, or copper alloy, with antimicrobial properties. The two or more layers of copper wool/screen/mesh may have substantially similar surface area, thickness, porosity, and/or density. The two or more layer of copper wool/screen/mesh may be stacked over each other with the separator screen 126 there between and positioned within the frame 140. For example, the first copper mesh screen 122 and the second copper mesh screen 124 may have substantially similar dimensions are stacked together, with the separator screen 126 there between. In some embodiments, further additional copper mesh screens may be utilized with an additional separator screen positioned between each adjacent pair of copper screens. In some embodiments, the first copper mesh screen 122 and the second copper mesh screen 124, and/or the back and front mesh screens 148, 149, nay be positioned in a channel of the frame 140 to hold the layers of the pathogen deactivation filter portion 120 in place.

As noted above, the base filter portion 110 may include or comprise the pathogen deactivation filter portion 120, and the pathogen deactivation filter portion 120 may include or comprise (at least) the first copper mesh screen 122, the separator screen 126, and the second copper mesh screen 124. As also noted above, the pathogen deactivation filter portion 120 may further include or comprise a back mesh 148 and a front mesh 149 that bounds the top and bottom surfaces of the pathogen deactivation filter portion 120.

In the illustrated exemplary embodiment, the frame 140 comprises four long frame panels, each panel connected to another perpendicular panel by an end piece that is capable of slotting or inserting another long panel. The four long frame panels and four end pieces together form a rectangle shape, as shown in FIGS. 1-3 and 13. As described above, other embodiments need not be limited to a rectangular shape or four end pieces (e.g., one continuous rectangular shape), as the filter system 100 may be any shape that can fit into a larger air filtering system may suffice.

As is seen in FIGS. 1-13, the back mesh 148 may from the front side of the pathogen deactivation filter portion 120, and may abut or be immediately adjacent to the particulate filter 130. The pathogen deactivation filter portion 120 may include the front screen 149, the second copper mesh screen 124, the separator screen 126, the first copper mesh screen 122 and the back screen 148 in order and immediately adjacent order and abutting/engagement with each other. The layers of the pathogen deactivation filter portion 120 may be pressed, glued, taped, and/or otherwise attached together. Alternatively, back mesh 148 and front mesh 149 may be attached to planar surfaces on the top and/or bottom of base filter portion 110, while first copper mesh screen 122, separator screen 126 and second copper mesh screen 124 may be attached together and placed within the borders created by back mesh 148 and front mesh 149. In the present embodiment, the first copper mesh screen 122, the second copper mesh screen 124, the separator screen 126, the back mesh 148, and the front mesh 149 each have approximately similarly sized shapes and sizes such that each of the features may be placed on top or on bottom of one another in a planar arrangement.

In some embodiments, a recess may exist slightly inwards from the borders of the perimeter of the bottom of base filter portion 110, such that front side frame channel portion 142, first side frame channel portion 144, and second side frame channel portion 146 may slot or insert into base filter portion 110. The recess may exist along only the borders where the channel portions 142, 144, 146 are placed or may exist around every edge of base filter portion 110. Furthermore, protrusions of base filter portion may extrude downwards from the bottom surface of base filter portion 110 (as shown in FIG. 12) that border the inserted channel portions 142, 144, 146 and provide additional stability for the channels. The channels (e.g., front side frame channel portion 142, first side frame channel portion 144, and second side frame channel portion 146) may be glued to the recess of base filter portion 110, pressed, screwed from the sides of base filter portion 110, nailed, and/or attached through other means to the base filter portion 110. The channel portions 142, 144, 146 may be protrusions that have a non-smooth surface (e.g., the right protrusion as depicted in FIG. 12) that adds additional support and fixation of the channels to the base filter portion 110, through friction, slots, etc. Also, recesses and/or protrusions may not be necessary, the channel portions 142, 144, 146 may be fixed to the frame 130 through other means, such as by placing channels around the bottom of the base portion 120 and fixing the channels to the bottom of base portion 120 through screws, glues, tape, or other means.

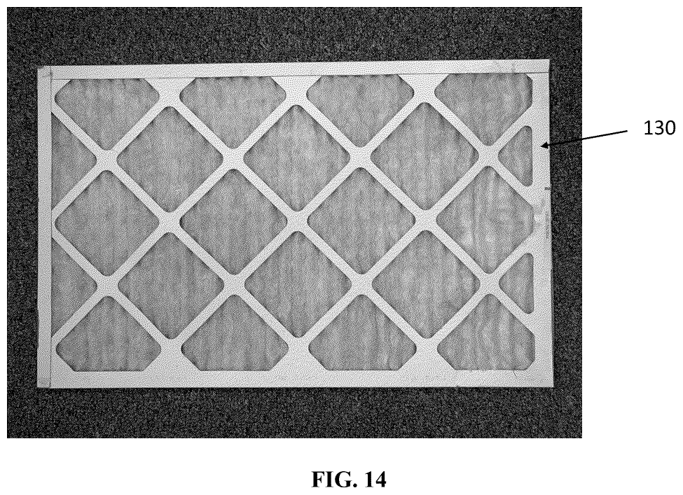

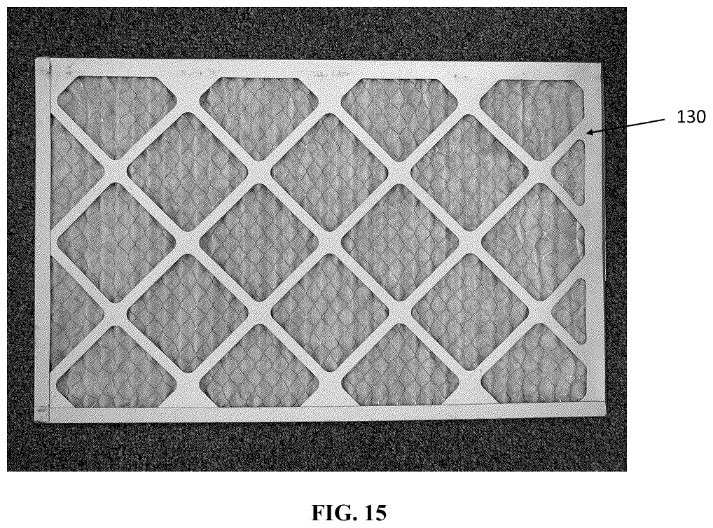

In some embodiments, the particulate filter 130 may include or comprise a conventional pleated air filter, such as a conventional pleated paper, fabric (woven or non-woven) or fiber (natural or synthetic, e.g., fiberglass) air filter. In some embodiments, the particulate filter 130 may have two or more filtering layers/material layers, and a support or reinforcement layer or framework. As shown in FIGS. 14-16, in some embodiments, the particulate filter 130 may include at least one filter material layer portion, a casing portion, and a wire frame portion. In some embodiments, a wire mesh may be positioned over one side of the pleated filter material portion (best seen in FIG. 15). In some embodiments, the filter material may not be pleated. In some embodiments, a wire or wire mesh may help attach the filtering portion. The casing portion may surround the pleated filtering portion and the attached wire frame portion. In some embodiments, the casing portion may be made of cardboard, though any appropriate material may be used, such as plastic, metal, etc. Additionally, particulate filter 130 may be any standard type of pleated air filter, such as at least a MERV 4 air filter, MERV 5 air filter, a MERV 6 air filter, a MERV 7 air filter, or a MERV 8 air filter.

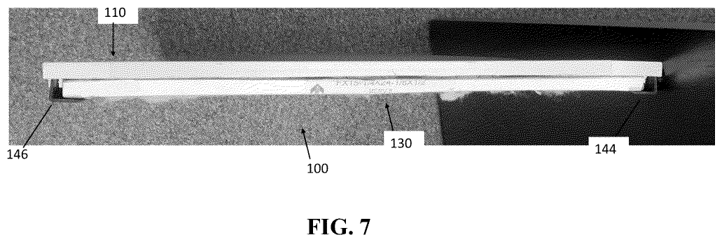

As illustrated in FIG. 7 and FIG. 8, a rear width of particulate filter 130 may be less than a width of base filter portion 110 so that particulate filter 130 may be placed within the retention channel and thereby coupled to the base filter portion 110. In alternate embodiments, the particulate filter 130 may have a similar or even larger width than base filter portion based on the configuration of the surrounding channels. In some embodiments, the particulate filter 130 may define a maximum thickness of less than 1 inch, such as about ½ inch.

FIG. 8 depicts an end cross-sectional view of the air filter system 100. The plurality of downward facing arrows indicate the path of travel of air laden with pathogens and other particulate. As depicted, air first passes through the particulate filter 130 (e.g., a MERV 5-13 conventional pleated air filter). In this embodiment, the particulate filter 130 removes most standard air pollutants. After passing through the particulate filter 130, the air then travels through either a front mesh 149 or straight to the second copper wool medium 126. Most pathogens, such as coronavirus, are deactivated when the pathogens come in contact with copper screens 122, 124. In this embodiment, the second copper wool medium is 30% open, which deactivates 70% of the virus. The air then travels through the separator screen 126, which functions to diffuse the airflow. The air then travels through the first copper mesh screen 122, which may deactivate 70% of the remaining pathogens. Thus, in a pass through the two copper screens, only 9% of the virus escapes. On a second pass through, only a negligible number of pathogens may remain. Though FIG. 8 illustrates the use of two copper wool mediums 122, 124 and a single separator screen 126, any number of copper wool mediums and separator screens may be used, including more and or less copper wool mediums and separator screens. Additionally, other types of material besides copper wool may be used that deactivate or filter out pathogens.

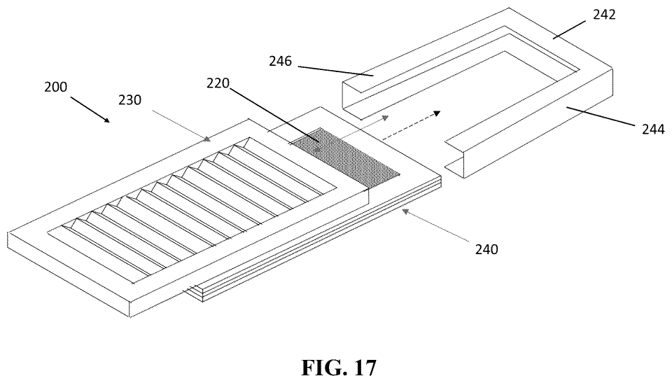

FIG. 17 depicts an exploded assembly perspective view of an alternate embodiment of an air filter system 200 that may inactivate airborne pathogens (e.g., viruses, bacteria, coronaviruses, COVID-19, etc.) flowing through a particulate filter 230 and a pathogen deactivation filter portion 220. The air filter system 200 is substantially similar to air filter system 100, and therefore like aspects are referenced with numerals beginning in “2” as opposed to “1”, and the description thereto equally applies and is not repeated herein for brevity sake.

As shown in FIG. 17, the air filter system 100 may include or be comprised of the pathogen deactivation filter portion 220, the particulate filter 230, and a frame 240. The pathogen deactivation filter portion 220 may include or be comprised of a first copper wool medium 222, a second copper wool medium 224, and a non-copper separator screen 226. Additionally, pathogen deactivation filter portion 220 may further include a back mesh 148 and a front mesh 149 made of metal. The first copper wool medium 222 and the second copper wool medium 224 may include or be comprised of copper, or copper alloys, with antimicrobial properties. The first copper wool medium 222 and the second copper wool medium 224—due to its antimicrobial properties-inactivates pathogens flowing therethrough. The separator screen 226 (non-copper) may diffuse the particles and pathogens passing therethrough in order to increase the efficiency of pathogen deactivation from the first copper wool medium 222 to the second copper wool medium 224.

The frame 240 may include a or may be comprised of a set of channels with an open end that allows the particulate filter 230 and the pathogen deactivation filter portion 220 to be slotted into the frame 240 and complete the air filter system 200 by joining the pathogen deactivation filter portion 210 and the particulate filter 230 and the frame 240. The pathogen deactivation filter portion 220 and the particulate filter 230 may be approximately similarly sized (e.g., in a rectangle shape) and may have an outer perimeter slightly smaller than the inner perimeter of the frame 240.

As shown in FIG. 17, the frame 240 may include a front side frame channel portion 242 with a hook-like cross-sectional shape (see FIG. 12) that connects to a first side frame channel portion 244 and a second side frame channel portion 246, both of which have similar shapes. The frame 240 thus may leave one side open for a particulate filter 230 to releasably insert into a cavity bounded on its sides by the first side frame channel portion 244, the second side frame channel portion 246, the base filter portion 210, and bounded at an end by the front side frame channel portion 242. The channel portions, instead of a hook-like cross-sectional shapes, may instead contain grooves within the channels that allow pathogen deactivation filter portion 220 and particulate filter 230 to releasably insert into the channel portions. Or, the channel portions could come in multiple parts that clip together around pathogen deactivation filter portion 220 and particulate filter 230. If the channel portions clip together, a frame that forms a complete cavity bounded on all sides may be possible. In some embodiments, as shown in FIG. 17, the frame 240 and pathogen deactivation filter portion 220 are rectangles, wherein the perimeter of frame 240 is slightly greater than the perimeter of pathogen deactivation filter portion 220.

Alternatively, frame 240 and pathogen deactivation filter portion 220 may have different shapes to accommodate the dimensions of a given air ventilation system. For example, frame 240, pathogen deactivation filter portion 120, and particulate filter 230 may be circular, wherein the circumference of frame 240 is slightly greater than the circumference of the pathogen deactivation filter portion 220 and the particulate filter 230. As a further alternative embodiment, pathogen deactivation filter portion 220 may include or be comprised of two or more copper, or copper alloys, with antimicrobial properties. For example, pathogen deactivation filter portion 120 may include or be comprised of a combination of UNS #C10100 and C10200.

As a further alternative embodiment, particulate filter 230 may include or comprise a handle attached to an end or side of the particulate filter 230 that will aid in inserting and/or removing the particulate filter 230 from the air filter system. Additionally, pathogen deactivation filter portion 220 may include or comprise a handle attached to an end or side of the pathogen deactivation filter portion 120 that will aide in inserting and/or removing the particulate filter 230 from the air filter system. Additionally, the frame 240 may include or comprise a handle attached to an end or side of the frame 230 that will aid in inserting and/or removing the air filter system 100 from its insertion (e.g., an HVAC system).

Repeated use of the present invention may cause build-up that reduces the efficiency and prevents air from flowing through air filter system 100/200 by build-up of particulates on the surfaces and the insides of pathogen deactivation filter portion 120/220 and particulate filter 130/230. Particulate filter 130/230 may need replacing with a new particulate filter 130/230. Pathogen deactivation filter portion 120/220 may be designed to be reused or recycled, through means such as washing with water, acids, and/or other specific products and methods designed to clean copper and/or other materials that may be used in pathogen deactivation filter portion 120/220.

In some embodiments, the base filter portion 110/210 is made of a composite of plastic and metal; the frame 140 is made of plastic; the particulate filter 130 is made of a combination of pleated filter material (paper, fabric, fibers, etc.), wire, and cardboard; and the pathogen deactivation filter portion 120 is made of copper wool and a non-copper separation material for air diffusion. However, the specific use of any of these materials should not be construed as limiting, as any materials that could replicate the function of these materials could be used as well. For example, any material that could deactivate pathogens could be used instead of copper, such as titanium, silver, graphene, cork, etc. Other materials may have advantages and/or disadvantages that would leverage the use of other materials instead of copper.

Multiple air filter systems 100/200 may be placed in series with one another, or multiple air filter systems 100/200 may be placed within a larger air filtration system to increase the efficiency of the system.

In some embodiments, with an upstream static air pressure of 0.60 inches of water, the air filter system/device 100 may effectuate a downstream static air pressure of 0.30 inches of water or greater, resulting in a pressure drop across the filter of 0.30 inches of water or less.

In some embodiments, the air filter system 100/200 may include components or features of the air filters disclosed in U.S. patent application Ser. No. 17/387,509, filed Jul. 28, 2021, and entitled Corona Disinfecting Air Filter Systems, the content of which is hereby incorporated herein by reference in its entirety.

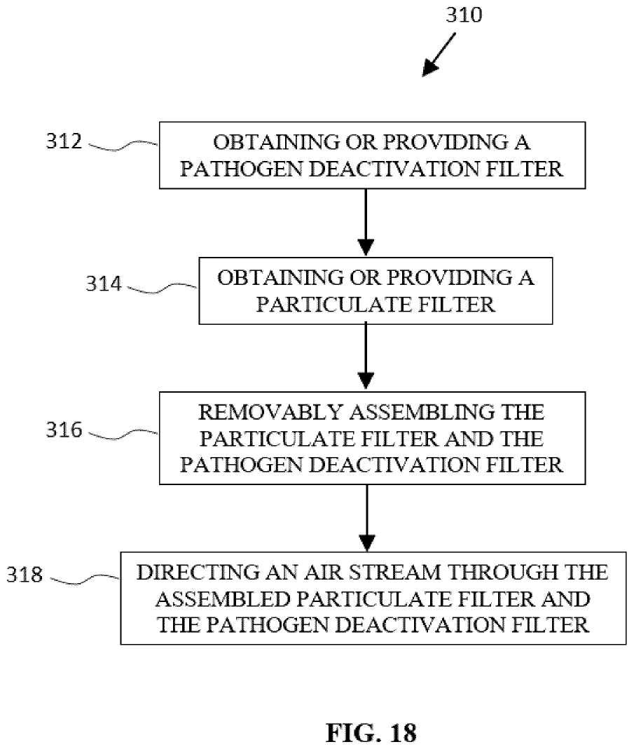

FIG. 18 illustrates a method 300 for removing or deteriorating airborne contaminants from air, according to an embodiment of the present disclosure. In this illustrated embodiment, method 300 may include, for example, at 310, obtaining or providing the pathogen deactivation filter configured to deactivate pathogens contained with an air stream flowing therethrough. As explained above, the pathogen deactivation filter may comprise: a first copper wool medium configured to inactivate viruses from the air stream flowing therethrough; a second copper wool medium configured to inactivate viruses from the air stream flowing therethrough; a non-copper separator screen disposed between the first copper wool medium and the second copper wool medium configured to randomize the airflow coming out of the first copper wool medium and into the second copper wool medium rather than filter the airflow; and a frame supporting a peripheral portion of a back side of the pathogen deactivation filter portion, the frame comprising channel portions on a front side of the frame that cooperatively form a retention channel that is open at a first end of the pathogen deactivation filter portion, and a first end of the frame is void of the channel portions such that the retention channel is open at the first end.

At 314, the method 300 may further include obtaining or providing the particulate filter configured to filter particulates from an air stream flowing therethrough with minimum efficiency reporting value of at least 5 MERV (or at least 8 MERV). The particulate filter may be configured as a conventional pleated air filter, but may define a maximum thickness of less than 1 inch, such as about ¾ inch or ½ inch.

At 316, the method 300 may also include removably assembling the particulate filter and the pathogen deactivation filter by slidably receiving the particulate filter within the retention channel from the first end such that the particulate filter extends over a front side of the pathogen deactivation filter portion. And, at 318, the method 300 may further include directing an air stream through the assembled particulate filter and the pathogen deactivation filter. In some such embodiments, directing an air stream through the assembled particulate filter and the pathogen deactivation filter comprises positioning the assembled particulate filter and the pathogen deactivation filter in a duct of an HVAC system, such as via a filter slot or cavity of an HVAC system.

It is to be understood that the above description is intended to be illustrative, and not restrictive. Numerous changes and modifications may be made herein by one of ordinary skill in the art without departing from the general spirit and scope of the disclosure as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the present disclosure has been described in detail in connection with only a limited number of embodiments, it should be readily understood that the present disclosure is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the disclosure may include only some of the described embodiments.

Components, aspects, features, configurations, arrangements, uses and the like described, illustrated or otherwise disclosed herein with respect to any particular embodiment may be similarly applied to any other embodiment disclosed herein. Accordingly, the present disclosure is not to be seen as limited by the foregoing description, but is only limited by the scope of the appended claims.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An air filter system configured to filter an air stream and inactivate pathogens within the air stream, the air filter system comprising:
a base filter portion comprising:
a pathogen deactivation filter portion comprising:
a first copper wool medium configured to inactivate viruses from the air stream flowing therethrough;
a second copper wool medium configured to inactivate viruses from the air stream flowing therethrough; and
a non-copper separator screen disposed between the first copper wool medium and the second copper wool medium configured to randomize the airflow coming out of the first copper wool medium and into the second copper wool medium rather than filter the airflow; and
a frame supporting a peripheral portion of a back side of the pathogen deactivation filter portion, the frame comprising channel portions on a front side of the frame that cooperatively form a retention channel that is open at a first end of the pathogen deactivation filter portion; and
a particulate filter positioned within the retention channel and extending over a front side of the pathogen deactivation filter portion, the particulate filter being configured to filter particulates from the air stream flowing therethrough,
wherein a first end of the frame is void of the channel portions such that the retention channel is open at the first end and the particulate filter is removably slidably received within the retention channel.

2. The air filter system of claim 1, wherein the degree of obstruction that the air filter imparts on the air stream flowing therethrough does not result in a significant increase in pressure drop.

3. The air filter system of claim 2, wherein the air filter system imparts a pressure drop of the air stream flowing therethrough of less 0.6 inches of water.

4. The air filter system of claim 2, wherein the air filter system imparts a pressure drop of the air stream flowing therethrough of less 0.35 inches of water.

5. The air filter system of claim 1, wherein the air filter system comprises a minimum efficiency reporting value of the air stream flowing therethrough of at least 8 MERV.

6. The air filter system of claim 1, wherein the first copper wool medium and the second copper wool medium each have a porosity of less than or equal to 3 μm.

7. The air filter system of claim 1, wherein the first copper wool medium and the second copper wool medium each impart a pressure drop on the air stream flowing therethrough of less than 0.30 inches of water.

8. The air filter system of claim 1, wherein the first copper wool medium and the second copper wool medium each comprise a mesh screen of at least 250 mesh.

9. The air filter system of claim 1, wherein the first copper wool medium and the second copper wool medium each comprise a mesh screen of at least 400 mesh.

10. The air filter system of claim 1, wherein the first copper wool medium and the second copper wool medium are each configured to inactivate coronaviruses from the air stream flowing therethrough.

11. The air filter of claim 1, wherein the first copper wool medium and the second copper wool medium each comprise one or more copper or copper alloys with antimicrobial properties.

12. The air filter of claim 1, wherein the pathogen deactivation filter portion further comprises a first non-copper randomizing screen extending over a front side of the first copper wool medium, the first copper wool medium being positioned between the first non-copper randomizing screen and the non-copper separator screen.

13. The air filter of claim 12, wherein the pathogen deactivation filter portion further comprises a support screen extending over a back side of the second copper wool medium, the second copper wool medium being positioned between the support screen and the non-copper separator screen.

14. The air filter of claim 1, wherein the channel portions extend from front face portions of the frame and inwardly toward an interior of the frame such that the retention channel is formed between the front face portions and the channel portions.

15. The air filter of claim 14, wherein the channel portions are L-shaped.

16. The air filter of claim 1, wherein the frame comprises a pair of opposing sides and a pair of opposing ends, and wherein the channel portions extend along the opposing sides and a second end of the opposing ends.

17. The air filter of claim 16, wherein the base filter portion defines a thickness that is about 1 inch or less, and wherein the particulate filter defines a thickness that is about ½ inch or less.

18. The air filter of claim 17, wherein the pair of opposing sides and the pair of opposing ends are configured such that the base filter portion is of a rectangular shape, wherein the particulate filter is of a rectangular shape.

19. The air filter of claim 1, wherein the particulate filter is a pleated air filter with a minimum efficiency reporting value of the air stream flowing therethrough of at least 5 MERV.

20. A method for removing and deactivating airborne pathogens from an air flow, the method comprising:
obtaining or providing a pathogen deactivation filter configured to deactivate pathogens contained with an air stream flowing therethrough, the pathogen deactivation filter comprising:
a first copper wool medium configured to inactivate viruses from the air stream flowing therethrough;
a second copper wool medium configured to inactivate viruses from the air stream flowing therethrough;
a non-copper separator screen disposed between the first copper wool medium and the second copper wool medium configured to randomize the airflow coming out of the first copper wool medium and into the second copper wool medium rather than filter the airflow; and
a frame supporting a peripheral portion of a back side of the pathogen deactivation filter portion, the frame comprising channel portions on a front side of the frame that cooperatively form a retention channel that is open at a first end of the pathogen deactivation filter portion, wherein a first end of the frame is void of the channel portions such that the retention channel is open at the first end;
obtaining or providing a particulate filter configured to filter particulates from an air stream flowing therethrough with minimum efficiency reporting value of at least 5 MERV;
removably assembling the particulate filter and the pathogen deactivation filter by slidably receiving the particulate filter within the retention channel from the first end such that the particulate filter extends over a front side of the pathogen deactivation filter portion; and
directing an air stream through the assembled particulate filter and the pathogen deactivation filter.
